(19) United States
(12) Patent Application Publication
(10) Pub. No.: US 2026/0260248 A1
(43) Pub. Date: Sep. 3, 2026

(54) PREDICTIVE ASSET MAINTENANCE USING A PREDICTIVE EMISSIONS MACHINE LEARNING MODEL

(71) Applicant: Honeywell International Inc., Charlotte, NC (US)

(72) Inventors: Sandhya Beejady, Bengaluru (IN); Minal Dani, Bengaluru (IN); Saumya Jain, Jabalpur (IN)

(21) Appl. No.: 19/066,484

(22) Filed: Feb. 28, 2025

(51) Int. Cl. G06Q 30/018; G06Q 10/20

(52) U.S. Cl. CPC G06Q 30/018; G06Q 10/20

(57) ABSTRACT

Devices, methods, and systems for predictive asset maintenance using a predictive emissions machine learning model are described herein. One method includes receiving, by a cloud computing device, operating parameters of a mechanical device, predicting, by a predictive emissions machine learning model of the cloud computing device using the operating parameters, an emission characteristic of the mechanical device, detecting, by the predictive emissions machine learning model based on the predicted emission characteristic being different than a current emission characteristic of the mechanical device under the operating parameters, that the mechanical device includes an operational emissions anomaly, categorizing, by the predictive emissions machine learning model, whether the operational emissions anomaly is related to an operational emissions anomaly that has previously occurred, and performing, by the cloud computing device, a root cause analysis on the operational emissions anomaly to determine a root cause of the operational emissions anomaly.

### TECHNICAL FIELD

The present disclosure relates generally to devices, methods, and systems for predictive asset maintenance using a predictive emissions machine learning model.

### BACKGROUND

Machine learning models can be used in asset anomaly detection and prediction for asset maintenance for mechanical devices such as boilers or other combustion-type mechanical devices. Such machine learning models can utilize and correlate different data points in order to predict whether an anomaly may exist within the mechanical device based on an emissions output from the mechanical device.

### BRIEF DESCRIPTION OF THE DRAWINGS

FIG. 1 illustrates an example system for predictive asset maintenance using a predictive emissions machine learning model in accordance with one or more embodiments.

FIG. 2 illustrates an example of attributes of impact associated with a mechanical device for predictive asset maintenance using a predictive emissions machine learning model in accordance with one or more embodiments.

FIG. 3 illustrates a flow diagram of an example method for predictive asset maintenance using a predictive emissions machine learning model in accordance with one or more embodiments.

FIG. 4 illustrates a block diagram of an example cloud computing device for predictive asset maintenance using a predictive emissions machine learning model in accordance with one or more embodiments.

### DETAILED DESCRIPTION

Devices, methods, and systems for predictive asset maintenance using a predictive emissions machine learning model are described herein. One method includes receiving, by a cloud computing device, operating parameters of a mechanical device, predicting, by a predictive emissions machine learning model of the cloud computing device using the operating parameters, an emission characteristic of the mechanical device, detecting, by the predictive emissions machine learning model based on the predicted emission characteristic being different than a current emission characteristic of the mechanical device under the operating parameters, that the mechanical device includes an operational emissions anomaly, categorizing, by the predictive emissions machine learning model, whether the operational emissions anomaly is related to an operational emissions anomaly that has previously occurred, and performing, by the cloud computing device, a root cause analysis on the operational emissions anomaly to determine a root cause of the operational emissions anomaly.

As mentioned above, machine learning models can be utilized for predictive asset maintenance. For example, a machine learning model can utilize various input data, such as operating parameters of a mechanical device, in order to model the operation of the mechanical device and predict whether a potential future operational anomaly may arise during operation of the mechanical device.

As a mechanical device operates, different operating modes and/or operating conditions can be experienced by the mechanical device over time. For example, the mechanical device’s emission efficiency may decrease and the mechanical device may start producing higher emissions under similar input operating parameters. This change may occur for different reasons, such as higher residuals in venting pipes, a change in environmental properties around the mechanical device, change in gas composition, less air ingestion for the combustion process, etc.

If these changing operating modes and/or operating conditions are not accounted for in the machine learning model, the machine learning model may not accurately predict the emissions output of the mechanical device. As a consequence, the true mechanical condition of the mechanical device may not align with that predicted by the machine learning model. Accordingly, predictive asset maintenance for the mechanical device as generated by the machine learning model may recommend maintenance work orders that are not necessary for the mechanical device and/or may not recommend maintenance work orders that are necessary for the mechanical device.

Predictive asset maintenance according to the disclosure can allow for a cloud computing solution for an artificial intelligence based predictive emissions machine learning model to predict an emission characteristic of the mechanical device using operating conditions of the device during a good (e.g., golden period) of operation and subsequently detect whether an operational emissions anomaly exists within the mechanical device based on the current emission characteristic of the mechanical device under the operating parameters being different than the predicted emission characteristic, and allow for a root cause analysis to be performed on the operational emissions anomaly if the operational emissions anomaly is actionable. For example, the predictive emissions machine learning model can be trained with training data having predetermined operating parameters so that the predictive emissions machine learning model outputs a predicted emissions characteristic that is within a threshold accuracy level. Over the course of the operational life of the mechanical device, the predictive emissions machine learning model can also be provided updated training data with modified operating parameters, allowing for the predictive emissions machine learning model to evolve as the life cycle of the mechanical device progresses, ensuring accurate prediction of emission characteristics of the mechanical device.

Additionally, the present disclosure may provide guided root cause analysis using an integrated knowledge graph to aid users in identifying and addressing the root cause of operational emission anomalies. This information may be used to identify systems and/or subsystems associated with the mechanical device that may contribute to and/or be impacted by the identified operational emissions anomaly.

Further, work orders can be generated for predictive asset maintenance of the mechanical device if the operational emission anomaly is actionable. Work orders can be performed in order to ensure the mechanical device operates in an efficient manner. Accordingly, such an approach can prevent operational downtime for the mechanical device, as well as ensure that the mechanical device operates within compliance and emissions standards set by associated governing bodies.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

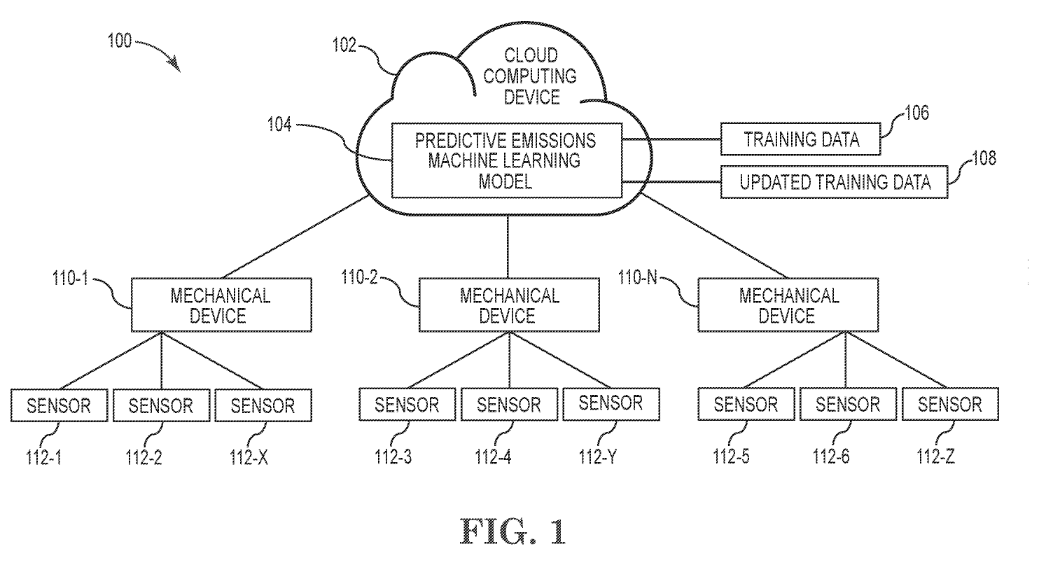

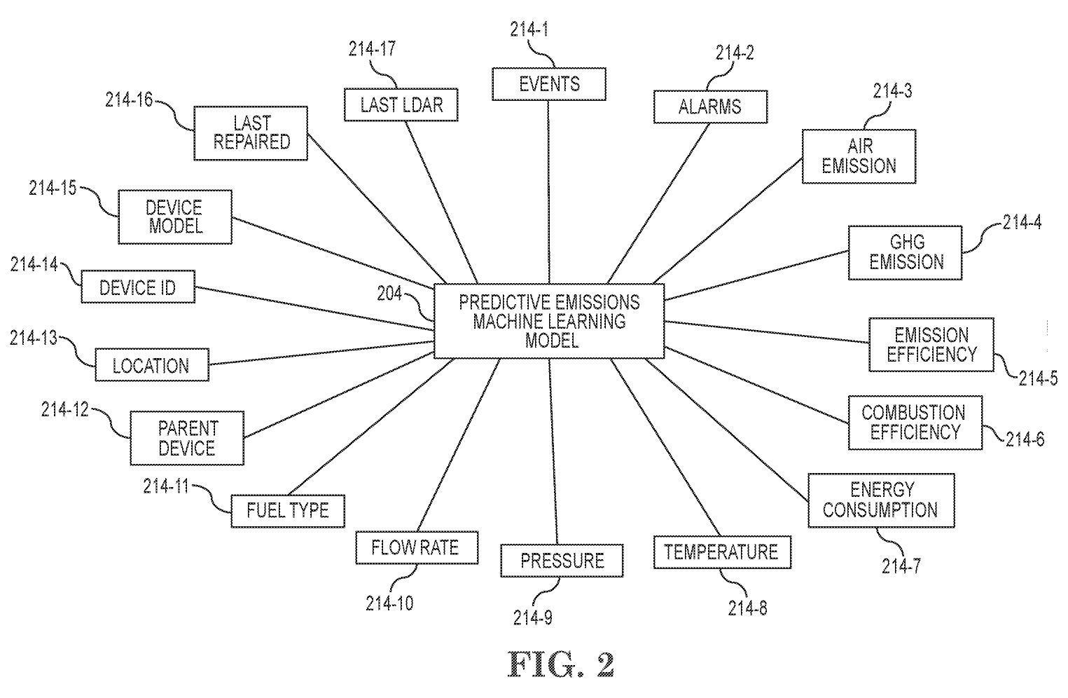

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designators “N”, “X”, “Y”, and “Z”, as used herein, particularly with respect to reference numerals in the drawings, indicates that a number of the particular feature so designated can be included with a number of embodiments of the present disclosure.

FIG. 1 illustrates an example system 100 for predictive asset maintenance using a predictive emissions machine learning model in accordance with one or more embodiments. The system 100 can include a cloud computing device 102 and a number of mechanical devices 110-1, 110-2, 110-N (collectively referred to herein as mechanical devices 110). The cloud computing device 102 can include a predictive emissions machine learning model 104 which can receive training data 106 and updated training data 108. Each of the mechanical devices 110 can include respective sensors 112-1, 112-2, 112-X, 112-3, 112-4, 112-Y, 112-5, 112-6, 112-Z (collectively referred to herein as sensors 112) associated therewith.

As mentioned above, a machine learning model can be utilized in asset anomaly detection and prediction for asset maintenance for mechanical devices 110, as is further described herein. As illustrated in FIG. 1, the system 100 can include a cloud computing device 102 having a predictive emissions machine learning model 104.

As used herein, the term “computing device” refers to an electronic system having a processing resource, memory resource, and/or an application-specific integrated circuit (ASIC) that can process information. Examples of computing devices can include, for instance, a laptop computer, a notebook computer, a desktop computer, an All-In-One (AIO) computing device, networking equipment (e.g., router, switch, etc.), and/or a mobile device, among other types of computing devices.

As illustrated in the system 100 of FIG. 1, the cloud computing device 102 can be remotely located from the mechanical devices 110. The cloud computing device 102 can be a computing device included as part of a cloud-computing environment. For instance, the cloud computing device 102 can be a computing device operating as part of a cloud computing environment remotely located from the mechanical devices 110 and can receive data from the mechanical devices 110 via a network (not shown in FIG. 1 for simplicity and so as not to obscure embodiments of the present disclosure).

The mechanical devices 110 can be connected to the cloud computing device 102 and/or to the sensors 112 via a wired and/or wireless network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of network relationships.

As illustrated in FIG. 1 and mentioned above, the cloud computing device 102 can include the predictive emissions machine learning model 104. As used herein, a machine learning model refers to a computing object trained on training data that can find patterns or make decisions based on an analysis of a previously unseen dataset. The predictive emissions machine learning model 104 can analyze data received from mechanical devices 110. Based on the analysis, the predictive emissions machine learning model 104 can generate an output that includes patterns detected by the predictive emissions machine learning model 104, including predicting an emission characteristic of the mechanical devices 110, detect whether any of the mechanical devices include an operational emissions anomaly, and/or categorize any detected operational emissions anomalies, as is further described herein.

As illustrated in FIG. 1, the system 100 can include mechanical devices 110. As used herein, a mechanical device can be a device that uses mechanical power to accomplish a particular task or function. The mechanical devices 110 can be, for instance, combustion devices that burn a fuel source in order to produce heat or power, where burning of the fuel source results in operational emissions from the combustion devices. Examples of combustion devices can include boilers, furnaces, or other types of combustion devices.

Mechanical devices 110 can each include sensors associated therewith. For example, mechanical device 110-1 can include associated sensors 112-1, 112-2, 112-X, mechanical device 110-2 can include associated sensors 112-3, 112-4, 112-Y, and mechanical device 110-N can include associated sensors 112-5, 112-6, 112-Z. As used herein, the term sensor refers to a device to detect events and/or changes in its environment and transmit the detected events and/or changes for processing and/or analysis. For example, the sensors 112-1, 112-2, 112-X can record data associated with the mechanical device 110-1 and transmit the data for processing and/or analysis, the sensors 112-3, 112-4, 112-Y can record data associated with the mechanical device 110-2 and transmit the data for processing and/or analysis, and the sensors 112-5, 112-6, 112-Z can record data associated with the mechanical device 110-N and transmit the data for processing and/or analysis.

The sensors 112 can be different types of sensors that can sense (e.g., measure) different types of information (e.g., data) that may be relevant to emissions of the mechanical devices 110. Examples of sensors 112 can include pressure sensors (e.g., water pressure, air pressure, etc.), temperature sensors, flow rate sensors, air quality sensors, among other types of sensors. For example, sensor 112-1 can be a pressure sensor that can acquire pressure related data related to operation of the mechanical device 110-1, sensor 112-2 can be a temperature sensor that can acquire temperature related data related to operation of the mechanical device 110-1, sensor 112-X can be a flow rate sensor that can acquire flow rate related data related to operation of the mechanical device 110-1, etc. Additionally, although not illustrated in FIG. 1 for clarity and so as not to obscure embodiments of the disclosure, the mechanical device 110-1 can include more than three sensors 112 or less than three sensors 112. Similarly, mechanical devices 110-2 and 110-N can include various numbers of sensors that can acquire data related to the operation of the mechanical devices 110-2, 110-N, respectively.

As mentioned above, the predictive emissions machine learning model 104 can be trained with training data 106. Training the predictive emissions machine learning model 104 can include utilizing training data 106 including predetermined operating parameters of a mechanical device and comparing an output from the predictive emissions machine learning model 104 using the training data with a known output. As used herein, the term operating parameter refers to measurements and controls that define how a mechanical device operates. Operating parameters can include, for instance, a pressure, temperature, flow rate, fuel type, fluid level, fuel-to-air ratio, energy consumption, combustion efficiency, emission efficiency, and/or other parameters that can define how a mechanical device operates. Training the predictive emissions machine learning model 104 in this way can allow for the predictive emissions machine learning model 104 to be able to predict expected emission characteristics for a mechanical device under the correct operating parameters, such as when the mechanical device is new (e.g., the golden period).

The predictive emissions machine learning model 104 can analyze the training data 106 and can generate an output including a predicted emission characteristic of the mechanical device. The predicted emission characteristic output can be generated by the execution of the predictive emissions machine learning model 104 on the training data 106 having the predetermined operating parameters. The predictive emissions machine learning model 104 can calculate an error of the predicted emission characteristic relative to a known target emission characteristic associated with the predetermined operating parameters, and adjust parameters of the predictive emissions machine learning model 104 so as to reduce this error. This process can be repeated until the predictive emissions machine learning model 104 outputs a predicted emissions characteristic associated with the predetermined operating parameters that is within a threshold accuracy amount. For example, the predictive emissions machine learning model 104 can repeat the training process until the error is less than a threshold value. Training the predictive emissions machine learning model 104 can, therefore, teach the predictive emissions machine learning model 104 to find patterns in the training data 106 that map the input data attributes to the desired target.

For example, the predictive emissions machine learning model 104 can be trained to predict emissions of a boiler by utilizing the training data 106 having predetermined operating parameters for a boiler. The predetermined operating parameters can include a predetermined pressure, temperature, fuel-to-air ratio, and/or other operating parameters that result in a predetermined emission characteristic. The predictive emissions machine learning model 104 can execute utilizing the training data 106 having the predetermined operating parameters and can generate and output an emission characteristic. The predictive emissions machine learning model 104 can compare the output emission characteristic to the predetermined emission characteristic, and if the error between the output emission characteristic and the predetermined emission characteristic is less than a threshold amount, the training process can stop. However, if the error between the output emission characteristic and the predetermined emission characteristic is greater than a threshold amount, the predictive emissions machine learning model 104 can repeat the training using the training data 106 until the error between the output emission characteristic and the predetermined emission characteristic is less than the threshold amount. In such a way, the predictive emissions machine learning model 104 can be trained to predict emission characteristics of the boiler device.

While the predictive emissions machine learning model 104 is described above as being trained with training data to predict an emission characteristic of a boiler, embodiments are not so limited. For example, the predictive emissions machine learning model 104 can be trained with training data to predict an emission characteristic of any other combustion-type mechanical device.

As mentioned above, as the mechanical devices 110 operate over their operational lifetime, the emissions from the mechanical devices 110 can also change. For example, as the mechanical devices 110 age, the mechanical devices 110 may output emissions that are different from when the mechanical devices 110 were new, even under the same operating conditions.

In order to account for this difference, the predictive emissions machine learning model 104 can be periodically retrained with updated training data 108. The updated training data can include modified operating parameters associated with an operational age of the mechanical devices 110. For example, similar to the process above, the predictive emissions machine learning model 104 can execute by analyzing the updated training data 108 and can generate an output including a predicted emission characteristic of the mechanical device. The predicted emission characteristic output can be generated by the execution of the predictive emissions machine learning model 104 on the updated training data 108 having the modified operating parameters associated with the age of the mechanical devices 110. The predictive emissions machine learning model 104 can calculate an error of the predicted emission characteristic relative to a known target emission characteristic associated with the modified operating parameters, and adjust parameters of the predictive emissions machine learning model 104 so as to reduce this error. This process can be repeated until the predictive emissions machine learning model 104 outputs a predicted emissions characteristic associated with the modified operating parameters that is within a threshold accuracy amount. For example, the predictive emissions machine learning model 104 can repeat the training process until the error is less than a threshold value. Training the predictive emissions machine learning model 104 can, therefore, update the predictive emissions machine learning model 104 to find patterns in the updated training data 108 as the mechanical device 110 ages.

For example, the predictive emissions machine learning model 104 can be updated to predict emissions of a boiler by utilizing the updated training data 108 having modified operating parameters for the boiler that are associated with the operational age of the boiler. The predictive emissions machine learning model 104 can execute utilizing the updated training data 108 having the modified operating parameters and can generate and output an emission characteristic. The predictive emissions machine learning model 104 can compare the output emission characteristic to the predetermined emission characteristic, and if the error between the output emission characteristic and the predetermined emission characteristic is less than a threshold amount, the training process can stop. However, if the error between the output emission characteristic and the predetermined emission characteristic is greater than a threshold amount, the predictive emissions machine learning model 104 can repeat the training using the updated training data 108 until the error between the output emission characteristic and the predetermined emission characteristic is less than the threshold amount. In such a way, the predictive emissions machine learning model 104 can be continuously trained to predict emission characteristics of the boiler device even as the boiler device ages through its operational lifecycle.

The updated training data 108 can be provided to the predictive emissions machine learning model 104 according to a predetermined frequency. For example, the updated training data 108 can be provided to the predictive emissions machine learning model 104 once a week, once a month, once a year, etc. Additionally, the predetermined frequency can be modifiable. Further, the predetermined frequency may be increased as the mechanical devices 110 gets older such that updated training data 108 is more frequently provided to and the predictive emissions machine learning model 104 is more frequently updated as the mechanical devices 110 get older.

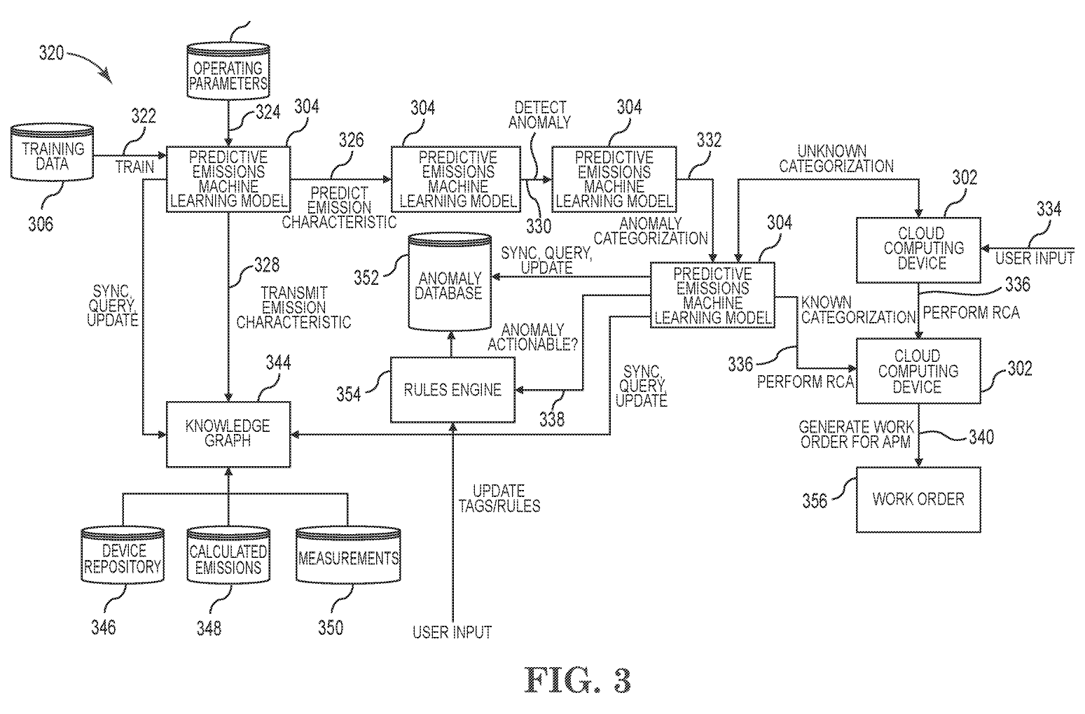

Accordingly, the predictive emissions machine learning model 104 can be located in the cloud computing device 102 and can be trained in order to predict an emission characteristic of a mechanical device over the operational lifecycle of the mechanical device. The predictive emissions machine learning model 104 can detect whether the mechanical devices 110 include an operational emissions anomaly, as is further described in connection with FIGS. 2 and 3, and can further categorize whether the operational emissions anomaly is related to an operational emission anomaly has previously occurred and perform a root cause analysis on the operational emissions anomaly to determine a root cause of the operational emissions anomaly, as is further described in connection with FIG. 3.

FIG. 2 illustrates an example of attributes of impact 214 associated with a mechanical device for predictive asset maintenance using a predictive emissions machine learning model in accordance with one or more embodiments. The example of attributes of impact 214 can be utilized by the predictive emissions machine learning model 204, which can be, for instance, the predictive emissions machine learning model 104 previously described in connection with FIG. 1, as is further described herein.

As previously described in connection with FIG. 1, the predictive emissions machine learning model 204 can be trained utilizing training data, as well as retrained using updated training data through an operational lifecycle of the mechanical device. The predictive emissions machine learning model 204 can be trained using training data (and updated training data) so that the predictive emissions machine learning model 204 can detect that a mechanical device includes an operational emissions anomaly. The predictive emissions machine learning model 204 can utilize the plurality of attributes of impact 214 in order to categorize whether the operational emissions anomaly is related to an operational emissions anomaly that has occurred in the past, as is further described in connection with FIG. 3. As described below, the plurality of attributes of impact 214, or a subset of the plurality of attributes of impact 214, can include an associated weight factor.

In the example illustrated in FIG. 2, the predictive emissions machine learning model 204 can utilize seventeen different attributes of impact 214, as are further described herein. However, embodiments are not so limited. For example, the predictive emissions machine learning model 204 can utilize more than seventeen attributes of impact 214 or less than seventeen attributes of impact 214. Additionally, the predictive emissions machine learning model 204 can dynamically select different ones of the attributes of impact 214 based on whether a particular attribute of impact has an impact on emissions of the mechanical device.

Attribute of impact 214-1 can be events. An event can be an occurrence of an action associated with the mechanical device. For example, an event may include a startup procedure of the mechanical device. The startup procedure of the mechanical device may not have a particular emission impact on the mechanical device and therefore may not include an associated weight factor.

Attribute of impact 214-2 can be alarms. An alarm can be an occurrence of a warning about a notable action that has taken place. For example, an alarm may be generated if an action of the mechanical device exceeds a threshold limit. For instance, an alarm may be generated if the temperature of the mechanical device exceeds a threshold value. In some examples, a particular type of alarm may have an emissions impact on the mechanical device, whereas other types of alarms may not have an emissions impact. The alarm in some instances, can include an associated weight factor of 5.

Attribute of impact 214-3 can be air emission of the mechanical device. Air emissions from the mechanical device can include particulates (e.g., PM 2.5, etc.) emitted from the mechanical device during operation of the mechanical device. The air emission of the mechanical device may have a particular emission impact on the mechanical device and can include an associated weight factor of 7.

Attribute of impact 214-4 can be greenhouse gas (GHG) emission of the mechanical device. GHG emissions from the mechanical device can include types of gases (e.g., carbon monoxide, nitrogen oxide, etc.) emitted from the mechanical device during operation of the mechanical device. The GHG emission of the mechanical device may have a particular emission impact on the mechanical device and can include an associated weight factor of 7.

Attribute of impact 214-5 can be an emission efficiency of the mechanical device. Emission efficiency can be a measure of how much carbon is emitted relative to an amount of economic output by the mechanical device. The emission efficiency can have a particular emission impact on the mechanical device and can include an associated weight factor of 10.

Attribute of impact 214-6 can be a combustion efficiency of the mechanical device. Combustion efficiency can be a measure of how effectively heat content of a fuel is converted into usable heat. The combustion efficiency can have a particular emission impact on the mechanical device and can include an associated weight factor of 10.

Attribute of impact 214-7 can be an energy consumption of the mechanical device. Energy consumption can be a measure of energy (e.g., electricity, heat, fuel, etc.) utilized by the mechanical device in order to produce an output (e.g., heat, steam, etc.). The energy consumption may not have a particular emission impact on the mechanical device but can include an associated weight factor of 5.

Attribute of impact 214-8 can be a temperature of the mechanical device. The temperature can be one of the operating parameters of the mechanical device and can have a particular emission impact on the mechanical device and can include an associated weight factor of 8.

Attribute of impact 214-9 can be a pressure of the mechanical device. The pressure can be one of the operating parameters of the mechanical device and can have a particular emission impact on the mechanical device and can include an associated weight factor of 9.

Attribute of impact 214-10 can be a flow rate of the mechanical device. The flow rate can be one of the operating parameters of the mechanical device and can have a particular emission impact on the mechanical device and can include an associated weight factor of 10.

Attribute of impact 214-11 can be a fuel type of the mechanical device. The fuel type can be a type of fuel the mechanical device utilizes in order to generate an output, and may include gas, fuel oil, kerosene, wood, coal, etc. The fuel type can have a particular emission impact on the mechanical device and can include an associated weight factor of 8.

Attribute of impact 214-12 can be a parent device of the mechanical device. A parent device can be, for example, a device that controls operation of the mechanical device, such as a controller. The parent device may not have a particular emission impact on the mechanical device and may not have an associated weight factor.

Attribute of impact 214-13 can be a location of the mechanical device. A location can be, for instance, a geographic location and can include latitude and longitudinal coordinates that specify the geographic location of the mechanical device. The location of the mechanical device may not have a particular emission impact on the mechanical device and may not have an associated weight factor.

Attribute of impact 214-14 can be a device identifier (ID) of the mechanical device. A device ID can identify a particular mechanical device, and may include identifiers such as a serial number, for example. The device ID may not have a particular emission impact on the mechanical device and may not have an associated weight factor.

Attribute of impact 214-15 can be a device model of the mechanical device. A device model can be, for example, a particular version of the mechanical device and can include a defined set of variables and/or equations that correspond to certain device characteristics and/or operation of the mechanical device. The device model may not have a particular emission impact on the mechanical device and may not have an associated weight factor.

Attribute of impact 214-16 can be when the mechanical device was last repaired. The date the mechanical device was last repaired may not have a particular emission impact on the mechanical device and may not have an associated weight factor.

Attribute of impact 214-17 can be when the mechanical device last underwent a leak detection and repair (LDAR) process. The date the mechanical device was last underwent an LDAR process may not have a particular emission impact on the mechanical device and may not have an associated weight factor.

As described above, the attributes of impact 214 can include associated weights on a scale between 1 and 10. However, embodiments are not so limited. For example, the attributes of impact 214 can be weighted according to any other weighting scale.

As described above, a subset of or the entirety of the attributes of impact 214 can be utilized to detect whether the mechanical device includes an operational emissions anomaly (e.g., as is further described in connection with FIG. 3). The predictive emissions machine learning model 204 can determine particular ones of the above attributes of impact for determination of the mechanical device including an operational emissions anomaly, categorize whether the operational emissions anomaly is related to an operational emission anomaly has previously occurred, and perform a root cause analysis on the operational emissions anomaly to determine a root cause of the operational emissions anomaly as is further described in connection with FIG. 3.

FIG. 3 illustrates a flow diagram of an example method 320 for predictive asset maintenance using a predictive emissions machine learning model in accordance with one or more embodiments. The method illustrated in FIG. 3 may be performed by the cloud computing device 102 and the predictive emissions machine learning model 104, as previously described in connection with FIG. 1. For instance, the predictive emissions machine learning model 304 and cloud computing device 302 illustrated in FIG. 3 may be predictive emissions machine learning model 104 and cloud computing device 102, respectively.

At 322, the method 320 includes training the predictive emissions machine learning model 304 with training data 306. As previously described above, training the predictive emissions machine learning model can include utilizing training data 306 including predetermined operating parameters for a mechanical device and comparing an output (e.g., a predicted emission characteristic) from the predictive emissions machine learning model 304 with a known expected output (e.g., an expected emission characteristic) for the predetermined operating parameters. This process can be repeated until the error between the predicted emission characteristic and the expected emission characteristic is within a threshold accuracy amount, such as less than a threshold error value.

Accordingly, once the predictive emissions machine learning model is trained, the predictive emissions machine learning model can receive, at 324, operating parameters 342 of the mechanical device during operation of the mechanical device. The predictive emissions machine learning model 304 can be used for predictive asset maintenance, as is further described herein.

The mechanical device can be, in some examples, a boiler. Accordingly, operating parameters 342 for a boiler can include a temperature, pressure, flow rate, fuel type, fluid level, fuel-to-air mixture, etc. for the boiler that define how the boiler operates. Additionally, the predictive emissions machine learning model 304 can determine certain operating parameters for the boiler including an energy consumption of the boiler, a combustion efficiency of the boiler, an emission efficiency of the boiler, etc. utilizing a subset of the operating parameters received at 324.

Using the operating parameters 342, at 326 the method 320 includes predicting an emission characteristic of the mechanical device by the predictive emissions machine learning model 304. For example, the predictive emissions machine learning model 304 can execute using the received operating parameters 342 and can generate an output including a predicted emission characteristic of the mechanical device. As used herein, the emission characteristic refers to a level of emissions by a mechanical device. Emission characteristics can include levels of oxides, nitric oxides (NOx), carbon, mercury, amounts of particulate, etc. released by the mechanical device during operation of the mechanical device. The predicted emission characteristic of the mechanical device, as described above and herein, is generated as the output of the predictive emissions machine learning model as opposed to a direct measurement of the emission characteristic of the mechanical device itself.

In one example, the predictive emissions machine learning model 304 can utilize the operating parameters 342 to predict an amount of NOx generated by a boiler during operation of the boiler. The predicted amount of NOx is generated via the predictive emissions machine learning model 304, as opposed to measuring the amount of NOx (e.g., via a sensor) generated by the operation of the boiler itself.

At 328, the method 320 can include transmitting the predicted emission characteristic to a knowledge graph 344 associated with the mechanical device. As used herein, a knowledge graph is a representation of connections between different entities. For example, the knowledge graph 344 can be a representation of connections between a mechanical device (e.g., a boiler) and related systems (e.g., valves, feed systems, exhaust systems, etc.) and sub-systems (e.g., burner, combustion chamber, heat exchanger, feedwater system, fuel system, steam distribution system, etc.). The knowledge graph 344 can, accordingly, utilize device repository information 346, calculated emissions 348, other measurements 350, as well as determined emission characteristics and categorized anomalies in order to add identifiers and descriptions to such data for integration and analysis for predictive asset maintenance. The knowledge graph 344 can be synchronized, queried, and/or updated during the method 320, as is further described herein.

As previously mentioned in FIG. 2, At 330, the method 320 includes detecting, by the predictive emissions machine learning model 304, that the mechanical device includes an operational emissions anomaly. As used herein, an operational emissions anomaly includes an operational emission from the mechanical device that deviates from an expected operational emission. For example, based on the predicted emission characteristic being different than a current emission characteristic of the mechanical device under the operating parameters, the predictive emissions machine learning model 304 can detect that the mechanical device includes an operational emissions anomaly. For instance, the predicted emission characteristic of the boiler can include a predicted amount of NOx of 50 parts per million (ppm). However, under the current operating parameters, it would be expected that the current emission characteristic of the boiler would be 30 ppm or less. Accordingly, since the predicted emission characteristic is different than a current emission characteristic of the boiler under the same operating parameters, the predictive emissions machine learning model 304 can detect that the boiler includes an operational emissions anomaly.

As the predictive emissions machine learning model 304 has detected that the mechanical device includes an operational emissions anomaly, the predictive emissions machine learning model 304 can further determine whether a related operational emissions anomaly has previously occurred. In order to do so, at 332, the method 320 includes categorizing, by the predictive emissions machine learning model 304, whether the operational emissions anomaly is related to an operational emissions anomaly that has previously occurred. For example, the predictive emissions machine learning model 304 can query the anomaly database 352, including previously detected operational emissions anomalies, and compare the operational emission anomaly from the mechanical device with the previously detected operational emissions anomalies included in the anomaly database 352 to determine whether the operational emission anomaly is related to an operational emissions anomaly that has previously occurred. The predictive emissions machine learning model 304 can determine, based on the comparison, whether any previously occurring operational emission anomalies (e.g., such as a predicted NOx level being higher than expected levels) associated with the particular operating parameters have occurred. If so, the predictive emissions machine learning model 304 can categorize the operational emissions anomaly as a high NOx level for the boiler via a categorization tag (e.g., a metadata object that gives context to data).

In an instance in which the predictive emissions machine learning model 304 determines a related operational emission anomaly has not previously occurred (e.g., an unknown categorization), at 334, the method 320 includes receiving, by the cloud computing device 302, a user input having a categorization tag for the predicted operational emissions anomaly. For example, if the predictive emissions machine learning model 304 is not able to categorize the operational emissions anomaly, a user provided categorization tag (e.g., high NOx level for the boiler) can be received by the cloud computing device 302 after the user reviews the predicted operational emissions anomaly. The predictive emissions machine learning model 304 can further update the anomaly database with the categorization tag received from the user.

The method 320 can further include categorizing, by the predictive emissions machine learning model 304, whether the operational emissions anomaly is related to the operational emissions anomaly that has occurred in the past by utilizing the plurality of attributes of impact associated with the mechanical device, as previously described in connection with FIG. 2. For example, the plurality of attributes can include flow rate, pressure, temperature, energy consumption, combustion efficiency, and emission efficiency. Based on the operating parameters, the predictive emissions machine learning model 304 can determine that the rate of change in value of the flow rate is high and can include a weightage of 10, that the pressure is low which is not normal and the weightage is 9, the temperature is high with a weightage of 8, energy consumption is high with a weightage of 5, combustion efficiency is low which is not normal with a weightage of 10, and emission efficiency is also low which is also not normal with a weightage of 10. The plurality of attributes of impact can be utilized by the predictive emissions machine learning model 304 in order to help determine whether the operational emissions anomaly is actionable, as is further described herein.

At 336, the method 320 includes performing a root cause analysis (RCA) on the operational emissions anomaly to determine a root cause of the operational emissions anomaly. Root cause analysis includes a systematic method of making inductive and deductive inferences in order to identify an underlying cause of an event. For example, the cloud computing device 302 can perform root cause analysis on the operational emissions anomaly having a categorization tag in order to determine a root cause of the operational emissions anomaly for the mechanical device, as is further described herein. As illustrated in FIG. 3, the root cause analysis 336 can be performed after receiving the user input of a categorization tag at 334 or following categorization of the operational emissions anomaly with a categorization tag (e.g., a known categorization) by the predictive emissions machine learning model 304.

In some examples, performing the root cause analysis on the operational emissions anomaly can include determining, by the cloud computing device 302, whether the operational emissions anomaly resulted from an operational fault associated with the mechanical device. The cloud computing device 302 can determine whether an operational fault exists and is causing the operational emissions anomaly utilizing any corresponding alarms, events, the operational emissions anomaly itself, utilizing the plurality of attributes of impact, etc. For example, an operational fault may include an anomalous input operating parameter, such as a high flow rate of liquid into the boiler, which can be causing the combustion efficiency to be low (e.g., causing the high NOx level) and where the high flow rate of liquid may be the result of a bad valve.

In some examples, performing the root cause analysis on the operational emissions anomaly can include determining, by the cloud computing device 302, whether a sensor associated with the mechanical device has detected a leak of material associated with the mechanical device. For example, the cloud computing device can gather data from sensors associated with the mechanical device to determine whether a fuel leak, water leak, steam leak, or any other type of leak may be causing the operational emissions anomaly (e.g., the high NOx level).

In some examples, performing the root cause analysis on the operational emissions anomaly can include determining, via the knowledge graph 344 associated with the predictive emissions machine learning model 304, whether a mechanical sub-system associated with the mechanical device caused the operational emission anomaly. For example, the cloud computing device 302 can utilize the knowledge graph 344 to determine whether an anomaly exists with the boiler’s sub-systems (e.g., whether an anomaly exists with the burner, combustion chamber, heat exchanger, feedwater system, fuel system, steam distribution system, etc.) which may be causing the high NOx level. Additionally and/or alternatively, the cloud computing device 302 can utilize the knowledge graph 344 to determine whether an anomaly exists with the boiler’s related systems (e.g., whether an anomaly exists with related valves, feed systems, exhaust systems, etc.) which may be causing the high NOx level.

Accordingly, the root cause analysis can identify an underlying cause of the operational emissions anomaly. For example, the root cause analysis can identify, for a high NOx level, any anomalous input operating parameters (e.g., low pressure but high flow rate and high temperature, that the combustion efficiency is low while the energy consumed by the boiler is high, and that the emission efficiency is low.). These anomalous input operating parameters can be used to identify the root cause of these anomalous input operating parameters, which may be a bad valve.

However, examples are not so limited. For instance, the cloud computing device 302 may further determine whether there are any related alarms, events, and whether any of the boiler’s related systems/sub-systems may be impacted due to the operational emissions anomaly. For example, the predictive emissions machine learning model 304 may utilize knowledge graph modeling via the knowledge graph 344 for the boiler’s related systems that may be impacted by the operational emissions anomaly.

At 338, the method 320 includes determining, by a rules engine 354, whether the operational emissions anomaly is actionable based on the categorization of the operational emissions anomaly and a tag correlation. As used herein, the term “actionable” refers to a state in which a sufficient reason exists in order to take an action. As used herein, the rules engine 354 includes a set of non-transitory machine-readable instructions that when, executed (e.g., by a processing resource), perform pre-defined rules by evaluating conditions against input data and performing corresponding actions. For example, the rules engine 354 can utilize the categorization of the operational emissions anomaly (e.g., the categorization tag correlated with the operational emissions anomaly and the weighted plurality of attributes of impact) and/or an amount of times the operational emissions anomaly has occurred, as is further described herein.

In some examples, the rules engine 354 can determine whether the operational emissions anomaly is actionable based on the categorization of the operational emissions anomaly and the correlated categorization tag. Continuing with the example from above, the categorization tag for the operational emissions anomaly can be the “high NOx level”, and the weighted plurality of attributes of impact can be the rate of change in value of the flow rate is high and can include a weightage of 10, the pressure is low which is not normal and the weightage is 9, the temperature is high with a weightage of 8, energy consumption is high with a weightage of 5, combustion efficiency is low which is not normal with a weightage of 10, and emission efficiency is also low which is also not normal with a weightage of 10. The rules engine 354 can determine that three of the plurality of attributes are not normal (e.g., pressure, combustion efficiency, and emission efficiency) for a high NOx level of a boiler. If the number of the plurality of attributes that are not normal exceed a threshold value for a particular operational emissions anomaly (e.g., high NOx level), the rules engine 354 can determine that the operational emissions anomaly is actionable.

In some examples, the rules engine 354 can determine an amount of times the operational emissions anomaly has occurred in the past. For example, rules engine 354 can determine that the operational emissions anomaly (e.g., high NOx level for a boiler) has occurred four times in the past. Accordingly, the rules engine 354 can compare the total number of times the operational emissions anomaly has occurred (including the current instance) (e.g., to be five) to a threshold value. Based on the total number of times the operational emissions anomaly has occurred (e.g., five) exceeding a threshold value (e.g., four), the rules engine 354 can determine that the operational emissions anomaly is actionable.

Although the rules engine 354 is described above as utilizing the weighted plurality of attributes of impact or the number of times an operational emissions anomaly has occurred exceeding a threshold value to determine whether an operational emissions anomaly is actionable, embodiments are not so limited. For example, the rules engine 354 can utilize a combination thereof (e.g., utilizing both the weighted plurality of attributes of impact and the number of times an operational emissions anomaly has occurred exceeding a threshold value) to determine an operational emissions anomaly is actionable. For instance, the rules engine 354 can determine an operational emissions anomaly is actionable in response to a number of the plurality of attributes that are not normal exceeding a threshold value for a particular operational emissions anomaly and the total number of times the operational emissions anomaly has occurred exceeding a threshold value to determine the operational emissions anomaly is actionable.

Determining whether an operational emissions anomaly is actionable can be utilized to effectively and efficiently utilize maintenance resources for mechanical devices. For instance, in some examples, an operational emissions anomaly may be predicted when upstream equipment may be shut off for unrelated maintenance. This disruption in upstream equipment may cause the operating parameters of the mechanical device to be changed, which may result in predicted operational emission anomalies for the mechanical device that are only occurring as a result of the disruption in upstream equipment and not necessarily because of a fault in the systems/sub-systems of or in the operation of the mechanical device itself. Accordingly, the actionable determination can prevent unnecessary work order generation for the mechanical device.

As illustrated in FIG. 3, the rules engine 354 can receive a user input. The user input can be an input to update categorization tags, rules, and/or weightage of attributes of impact for mechanical devices and/or certain known operational emissions anomalies. Users may include subject matter experts, data scientists, or others who can provide updates to the rules engine over time.

At 340, the method 320 includes generating a work order 356 for predictive asset maintenance of the mechanical device to address the operational emissions anomaly in response to determining the operational emissions anomaly is actionable. As mentioned above, an actionable operational emissions anomaly is an operational emissions anomaly that is in a state in which an action should be taken in order to address the operational emission anomaly. Accordingly, the cloud computing device 302 can generate a work order in order to remedy the operational emissions anomaly, as is further described herein.

For example, the cloud computing device 302 can generate a work order that includes a maintenance task as well as a process for completing the maintenance task. Continuing with the example from above, the work order 356 can include the root cause analysis for the high NOx level (e.g., previously described above) including any anomalous input operating parameters (e.g., low pressure but high flow rate and high temperature, combustion efficiency being low while energy consumed being high, and emission efficiency being low) which may be the result of a bad valve, any related alarms, events, and knowledge graph based emission modeling for any of the boiler’s related systems that may be impacted due to the operational emissions anomaly. The work order can include steps to remedy the operational emissions anomaly (e.g., replacing the bad valve). Further, the work order 356 can include additional information such as a time stamp of when the operational emissions anomaly was detected as well as for how long the operational emissions anomaly has been detected.

Although the embodiments described above utilize a boiler as an example mechanical device, embodiments are not so limited. For example, the predictive asset maintenance using a predictive emissions machine learning model 304 can be utilized with any other mechanical combustion type device. Examples of such devices may include boilers, furnaces, heaters, and/or any other combustion-type devices.

Accordingly, predictive asset maintenance using a predictive emissions machine learning model according to the disclosure can allow for prediction of an emission characteristic of a mechanical device and detection of whether an operational emissions anomaly exists within the mechanical device based on the predicted emission characteristic. Utilizing a predictive emissions machine learning model, trained on training data, the predictive emissions machine learning model can detect the operational emissions anomaly based on the predicted emission characteristic being different than a current emission characteristic for the mechanical device under the same operating parameters. Additionally, over the course of the operational life of the mechanical device, the predictive emissions machine learning model can be re-trained utilizing updated training data so that the predictive emissions machine learning model can predict an emission characteristic of the mechanical device according to the true operation of the mechanical device even as the mechanical device ages.

Further, the predictive emissions machine learning model can categorize a detected operational emission anomaly and provide guided root cause analysis to aid users in identifying and addressing the root cause of the operational emissions anomaly. Lastly, work orders can be generated if the operational emissions anomaly is actionable in order to address the operational emission anomaly to provide predictive asset maintenance for the mechanical device. Accordingly, such an approach can prevent operational downtime for the mechanical device, as well as ensure that the mechanical device operates within compliance and emissions standards set by associated governing bodies.

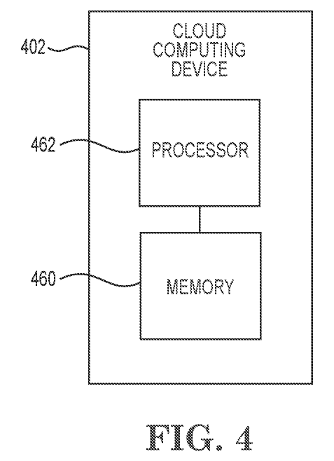

FIG. 4 illustrates a block diagram of an example cloud computing device 402 for predictive asset maintenance using a predictive emissions machine learning model in accordance with one or more embodiments. Cloud computing device 402 can be, for example, cloud computing device 102 previously described in connection with FIG. 1. As illustrated in FIG. 4, the cloud computing device 402 can include a memory 460 and a processor 462 for predictive asset maintenance using a predictive emissions machine learning model in accordance with the present disclosure.

The memory 460 can be any type of storage medium that can be accessed by the processor 462 to perform various examples of the present disclosure. For example, the memory 460 can be a non-transitory computer readable medium having computer readable instructions (e.g., executable instructions/computer program instructions) stored thereon that are executable by the processor 462 for predictive asset maintenance using a predictive emissions machine learning model in accordance with the present disclosure.

The memory 460 can be volatile or nonvolatile memory. The memory 460 can also be removable (e.g., portable) memory, or non-removable (e.g., internal) memory. For example, the memory 460 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 460 is illustrated as being located within cloud computing device 402, embodiments of the present disclosure are not so limited. For example, memory 460 can also be located internal to another computing resource (e.g., enabling computer readable instructions to be downloaded over the Internet or another wired or wireless connection).

The processor 462 may be a central processing unit (CPU), a semiconductor-based microprocessor, and/or other hardware devices suitable for retrieval and execution of machine-readable instructions stored in the memory 460. The processor 462 may be in communication with the memory 460 via a bus for passing information among components of the cloud computing device 402. The processor 462 may include one or more processing devices configured to perform independently in some embodiments. Alternatively, the processor 462 may include one or more processing devices configured to perform concurrently to execute one or more instructions stored in memory 460.

In some embodiments, the processor 462 may be configured to execute instructions stored in a storage subsystem, and/or circuitry otherwise accessible to the processor 462.

The cloud computing device 402 can include input/output circuitry in some embodiments. The input/output circuitry may be in communication with processor 462 to provide an output (e.g., to a user) or receive an indication of an input (e.g., by a user). The input/output circuitry may include a user interface, which may be a display, a web user interface, a mobile application, or a query initiating computing device, in some examples. The input/output circuitry may also include a keyboard, a mouse, a joystick, a touch screen, a microphone, a speaker, or other input/output mechanisms.

The cloud computing device 402 may include communications circuitry, in some embodiments of the present disclosure. The communications circuitry may include circuitry embodied in hardware and/or software that is configured to receive and/or transmit data to/from a network. Communications circuitry may be configured to transmit data to/from other devices, circuitry, or modules in communication with the cloud computing device 402. The communications circuitry may include one or more network interface cards, buses, modems, switches, and/or routers for enabling communications via a network.

The cloud computing device 402 can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that device. Further, while a single computing device is illustrated, the term “computing device” shall also be taken to include any collection of devices that individually or jointly execute a set (or multiple sets) of instructions to perform any one or more of the methodologies discussed herein.

In alternative embodiments, the cloud computing device 402 can be connected (e.g., networked) to other computing devices in a LAN, an intranet, an extranet, and/or the Internet. The cloud computing device can operate in the capacity of a server or a client device in client-server network environment, as a peer device in a peer-to-peer (or distributed) network environment, or as a server or a client device in a cloud computing infrastructure or environment.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for predictive asset maintenance using a predictive emissions machine learning model, comprising:
receiving, by a cloud computing device, operating parameters of a mechanical device;
predicting, by a predictive emissions machine learning model of the cloud computing device using the operating parameters, an emission characteristic of the mechanical device;
detecting, by the predictive emissions machine learning model based on the predicted emission characteristic being different than a current emission characteristic of the mechanical device under the operating parameters, that the mechanical device includes an operational emissions anomaly;
categorizing, by the predictive emissions machine learning model, whether the operational emissions anomaly is related to an operational emissions anomaly that has previously occurred; and
performing, by the cloud computing device, a root cause analysis on the operational emissions anomaly to determine a root cause of the operational emissions anomaly.

2. The method of claim 1, wherein the method includes determining, by a rules engine of the cloud computing device, whether the operational emissions anomaly is actionable based on the categorization of the operational emissions anomaly and a tag correlation.

3. The method of claim 2, wherein the method includes determining, by the rules engine, the operational emissions anomaly is actionable in response to an amount of times the operational emissions anomaly has occurred exceeding a threshold.

4. The method of claim 3, wherein the method includes generating, by the cloud computing device, a work order for predictive asset maintenance of the mechanical device to address the operational emissions anomaly in response to determining the operational emissions anomaly is actionable.

5. The method of claim 1, wherein the method includes categorizing, by the predictive emissions machine learning model, whether the operational emissions anomaly is related to the operational emissions anomaly that has occurred in the past by utilizing a plurality of attributes of impact associated with the mechanical device, wherein each of the plurality of attributes of impact includes an associated weight factor.

6. The method of claim 1, wherein performing the root cause analysis includes determining, by the cloud computing device, whether the operational emissions anomaly resulted from an operational fault associated with the mechanical device.

7. The method of claim 1, wherein performing the root cause analysis includes determining, by the cloud computing device, whether a sensor associated with the mechanical device has detected a leak of material associated with the mechanical device.

8. The method of claim 1, wherein performing the root cause analysis includes determining, via a knowledge graph associated with the predictive emissions machine learning model, whether a mechanical sub-system associated with the mechanical device caused the operational emissions anomaly.

9. A cloud computing device for predictive asset maintenance using a predictive emissions machine learning model, comprising:
a processing resource; and
a memory resource storing non-transitory machine-readable instructions to cause the processing resource to:
receive operating parameters of a mechanical device;
predict, by a predictive emissions machine learning model of the cloud computing device using the operating parameters, an emission characteristic of the mechanical device;
detect, by the predictive emissions machine learning model based on the predicted emission characteristic being different than a current emission characteristic of the mechanical device under the operating parameters, that the mechanical device includes an operational emissions anomaly;
categorize, by the predictive emissions machine learning model, whether the operational emissions anomaly is related to an operational emissions anomaly that has previously occurred, wherein the related operational emissions anomaly is stored in an anomaly database;
perform a root cause analysis on the operational emissions anomaly to determine a root cause of the operational emissions anomaly; and
determine, by a rules engine of the cloud computing device, whether the operational emissions anomaly is actionable based on the categorization of the operational emissions anomaly and a tag correlation.

10. The computing device of claim 9, wherein the processing resource is configured to determine, by the predictive emissions machine learning model, whether the related operational emissions anomaly has previously occurred.

11. The computing device of claim 10, wherein in response to determining the related operational emission anomaly has not previously occurred, the processing resource is configured to receive a categorization tag for the operational emissions anomaly via a user input.

12. The computing device of claim 11, wherein the processing resource is configured to perform the root cause analysis on the operational emissions anomaly having the categorization tag.

13. The computing device of claim 11, wherein the processing resource is configured to update the anomaly database with the categorization tag.

14. The computing device of claim 9, wherein the mechanical device is a combustion device.

15. The computing device of claim 9, wherein the operating parameters include at least one of:
a flow rate;
a pressure;
a temperature;
an energy consumption;
a combustion efficiency; and
an emission efficiency.

16. A non-transitory computer readable medium storing instructions executable by a processing resource to cause the processing resource to:
receive operating parameters of a mechanical device;
predict, by a predictive emissions machine learning model using the operating parameters, an emission characteristic of the mechanical device;
detect, by the predictive emissions machine learning model based on the predicted emission characteristic being different than a current emission characteristic of the mechanical device under the operating parameters, that the mechanical device includes an operational emissions anomaly;
categorize, by the predictive emissions machine learning model, whether the operational emissions anomaly is related to an operational emissions anomaly that has previously occurred, wherein the related operational emissions anomaly is stored in an anomaly database;
perform a root cause analysis on the operational emissions anomaly to determine a root cause of the operational emissions anomaly;
determine, by a rules engine, whether the operational emissions anomaly is actionable based on the categorization of the operational emissions anomaly and a tag correlation; and
generate a work order for predictive asset maintenance of the mechanical device to address the operational emissions anomaly in response to determining the operational emissions anomaly is actionable.

17. The non-transitory computer readable medium of claim 16, comprising instructions to train the predictive emissions machine learning model by providing the predictive emissions machine learning model with training data including predetermined operating parameters of the mechanical device.

18. The non-transitory computer readable medium of claim 17, comprising instructions to train the predictive emissions machine learning model using the training data until the predictive emissions machine learning model outputs a predicted emissions characteristic associated with the predetermined operating parameters that is within a threshold accuracy level.

19. The non-transitory computer readable medium of claim 17, comprising instructions to retrain the predictive emissions machine learning model by providing the predictive emissions machine learning model with updated training data including modified operating parameters associated with an operational age of the mechanical device.

20. The non-transitory computer readable medium of claim 19, comprising instructions to provide the updated training data to the predictive emissions machine learning model according to a predetermined frequency.
